(19) United States
(12) Patent Application Publication
(10) Pub. No.: US 2013/0117855 A1
(43) Pub. Date: May 9, 2013

(54) APPARATUS FOR AUTOMATICALLY INSPECTING SECURITY OF APPLICATIONS AND METHOD THEREOF

(71) Applicants: Sin Hyo Kim, Daejeon (KR); Seung Wan Han, Daejeon (KR); Jong Sik Moon, Daejeon (KR); Hyunsook Cho, Daejeon (KR)

(72) Inventors: Sin Hyo Kim, Daejeon (KR); Seung Wan Han, Daejeon (KR); Jong Sik Moon, Daejeon (KR); Hyunsook Cho, Daejeon (KR)

(73) Assignee: Electronics and Telecommunications Research Institute, Daejeon (KR)

(21) Appl. No.: 13/602,026

(22) Filed: Aug. 31, 2012

(30) Foreign Application Priority Data
Nov. 9, 2011 (KR) 10-2011-0116278

(51) Int. Cl. G06F 21/00

(52) U.S. Cl. 726/24

(57) ABSTRACT

An apparatus automatically inspects security of mobile applications. The apparatus includes a static analyzer to perform a static analysis by reversing an execution file of the mobile application, and an automatic execution processor to generate an automatic execution script used to automatically execute the execution file and execute the automatic execution script automatically to generate a log. The apparatus further includes a dynamic analyzer to analyze whether a pattern of malicious codes was executed in the execution file using the result of the static analysis and the log resulted from the automatic execution.

### RELATED APPLICATION(S)

This application claims the benefit of Korean Patent Application No. 10-2011-0116278, filed on Nov. 9, 2011, which is hereby incorporated by reference as if fully set forth herein.

### FIELD OF THE INVENTION

The present invention relates to a method for inspecting security of mobile applications, and more particularly, to an apparatus and method for automatically inspecting security of mobile applications downloaded and installed in a mobile communication terminal before the applications are distributed.

### BACKGROUND OF THE INVENTION

Recently, a software development environment for mobile terminals has been opened with the advent of smart phones being mobile phones and a terminal ecosystem with a developer revenue model has been created, so that many mobile applications or APP are being developed. The mobile applications developed as such are being distributed in a variety of forms, which can be posted on individual blogs and home pages to be downloaded, as well as APP stores provided by communication businesses.

However, in case of mobile applications provided by unreliable sites, individual terminal environments may be left very vulnerable since the developer with ill intensions may reveal individual information inside the mobile terminal to the outside or force unintended applications to run. Further, the mobile terminal environment has limitation to monitor threat situations in a real time and respond to them immediately, like a personal computer environment. It is because the mobile terminal environment is inferior to the personal computer environment in computing process capability and battery consumption by background process is too much in the mobile environment where power is not always connected.

Due to the above reasons, most mobile applications should be sufficiently inspected before their distribution to determine whether they have security, that is, the applications perform abnormal actions or make abnormal network accesses. However, since there is a possibility of copyright infringement when the software developer is requested to submit the source codes in such an inspection, an analysis needs to be performed with respect to the execution files of the mobile applications. However, if the security should be inspected by spending lots of time and efforts using many testers, it may damage cost competition of the mobile application and incur an inconvenient situation where terminal users cannot use the applications that should be used urgently.

### SUMMARY OF THE INVENTION

In view of the above, the present invention provides an apparatus and method for automatically inspecting security of mobile applications downloaded and installed in a mobile communication terminal before the applications are distributed.

Embodiments relates to an apparatus for automatically inspecting security of mobile applications and a method for automatically inspecting security of mobile applications.

In the embodiments, the apparatus includes: a static analyzer configured to perform a static analysis by reversing an execution file of the mobile application; an automatic execution processor configured to generate an automatic execution script used to automatically execute the execution file and execute the automatic execution script automatically to generate a log; and a dynamic analyzer configured to analyze whether a pattern of malicious codes was executed in the execution file using the result of the static analysis and the log resulted from the automatic execution.

In the embodiments, the apparatus the static analyzer performs a structural analysis, a permission analysis, and control and data stream analysis of the execution file by the reversing.

In the embodiments, the static analyzer automates a process of the static analysis by making a detailed description for a class and a method of the execution file.

In the embodiments, the automatic execution processor generates a test case automatically using information generated by the static analysis, and generates the automatic execution script on the basis of the test case.

In the embodiments, the dynamic analyzer analyzes control stream, data stream and permission for the execution file using the result of the static analysis and the log resulted from the automatic execution, thereby drawing a log analysis result, and analyzes the drawn log analysis result in each category and each level, thereby analyzing whether the pattern of malicious codes was executed in the execution file.

In the embodiments, the log analysis in each category is performed for networks, peripheral devices or Internet accesses in which the execution file is used.

In the embodiments, the log analysis in each level is performed for the system or application levels in which the execution file is executed.

In the embodiments, the method includes: performing a static analysis by reversing an execution file of the mobile application to be analyzed; generating a script to automatically execute the execution file; executing the script automatically to generate a log; and analyzing whether a pattern of malicious codes was executed in the execution file using the result of the static analysis and the log resulted from the automatic execution.

In the embodiments, performing the static analysis includes: analyzing a structure of the execution file by the reversing; analyzing whether a permission defined in the execution file is appropriate; and analyzing control and data stream of the execution file.

In the embodiments, generating the log includes: generating a test case automatically using information generated by the static analysis; generating a script to automatically execute the execution file on the basis of the test case; and generating a log by automatically executing the script.

In the embodiments, analyzing whether a pattern of malicious codes was executed in the execution file includes: performing analyses of control streams, data streams and permissions for the execution file using the result of the static analysis and the log resulted from the automatic execution, thereby drawing a log analysis result; and analyzing whether the pattern of malicious codes was executed in the execution file by analyzing the drawn log analysis result in each category and each level.

In the embodiments, the log analysis in each category is performed for networks, peripheral devices or Internet accesses in which the execution file is used.

In the embodiments, the log analysis in each level is performed for systems or application files in which the execution file is executed.

### BRIEF DESCRIPTION OF THE DRAWINGS

The above and other objects and features of the present invention will become apparent from the following description of embodiments, given in conjunction with the accompanying drawings, in which:

FIG. 1 is a block diagram illustrating an apparatus for automatically inspecting security of mobile applications in accordance with an exemplary embodiment of the present invention; and

FIG. 2 is a flow chart illustrating a method for automatically inspecting security of mobile applications in accordance with an exemplary embodiment of the present invention.

### DETAILED DESCRIPTION OF THE EMBODIMENTS

Hereinafter, a preferred embodiment of the present invention will be described with reference to the accompanying drawings. Further, when it is determined that a detailed explanation of known function or construction related when describing the present invention unnecessarily obscures the gist of the present invention, its detailed description will be omitted.

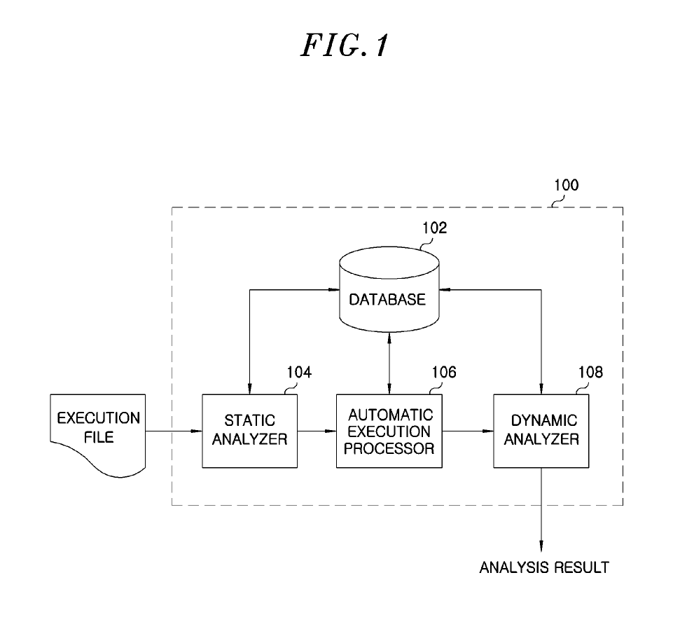

FIG. 1 is a block diagram illustrating an apparatus 100 for automatically inspecting security of mobile applications in accordance with an exemplary embodiment of the present invention.

An apparatus 100 for automatically inspecting security of mobile applications includes a static analyzer 104, an automatic execution processor 106 and a dynamic analyzer 108.

The static analyzer 104 reverses the execution file in a mobile application using a software reverse engineering, that is, reversing technology in order to determine malicious codes in the state that users are minimally involved and automatically generates basic data for a static analysis of the execution file to be analyzed. The static analyzer 104 also automates a process of the static analysis by analyzing and showing a structure of the execution file, a permission of the execution file and stream of control and data in a diagram format, and showing a detailed description for class and method.

The automatic execution processor 106 makes tests possible in the state users are minimally involved by automatically drawing possible text cases on the basis of control/data stream that are result of the static analysis. That is, the automatic execution processor 106 makes an automatic execution scripts to automatically execute the execution files to create a script with no omitted content in the automatic execution script on the basis of the test cases obtained from the static analysis. The automatic execution scripts generated as such automatically execute the execution files, generating various forms of records, that is, logs.

The dynamic analyzer 108 makes comparison, analysis and integration of analyzed results of control stream, data stream and permission using information in the database 102 obtained by the static analysis and automatic execution, performs a log analysis of in category of information revelation such as network, peripherals of camera and speaker, and Internet accesses, or a log analysis in system or application level, and generates the analysis result with respect to the analyzed application.

As described above, in accordance with the present invention, when performing process of static and dynamic analyses to determine whether malicious codes are concealed in the execution file of the mobile application, the static analysis is performed by reversing the mobile application having no source code and regenerating codes having high legibility, and its result is utilized in the dynamic analysis. Further, an automatic test case is made in order that users can make the analysis using a little effort and time only, dynamic analysis data are collected by generating and executing the automatic script, and the static analysis results are combined, so that the users can generally determine whether there are malicious codes.

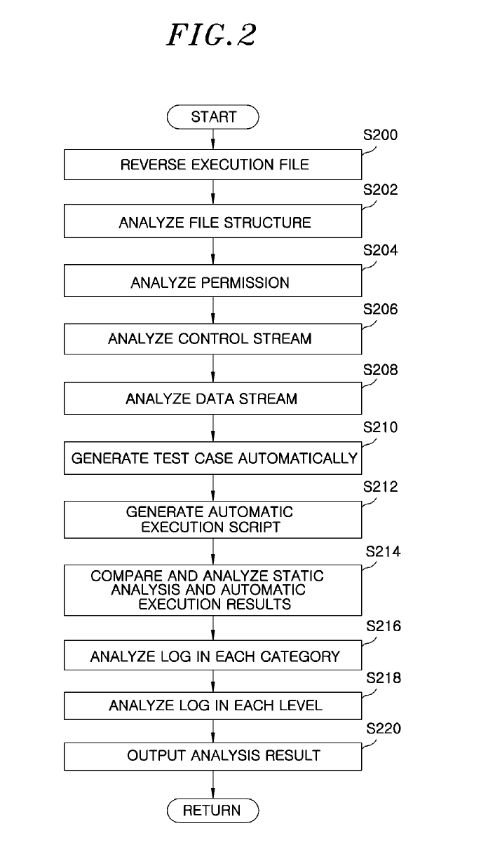

FIG. 2 illustrates a control flow of security inspection process operation to determine whether there are malicious codes in a mobile application using the apparatus 100 for automatically inspecting security of mobile applications in accordance with an exemplary embodiment of the present invention.

First, when an execution file in the mobile application to be analyzed is provided to the apparatus 100, the execution file is reversed in order to understand a general structure of the execution file in the static analyzer 104 to generate basic data for the static analysis in operation 5200.

Next, the static analyzer 104 analyzes the structure of the execution file on the basis of the analyzed result by reversing the execution file in operation 5202, and performs a permission analysis of the execution file in step S204.

Subsequently, the static analysis 104 analyzes a control stream between a class and a method, which are used in the mobile application, in operation S206, and analyzes a data stream therebetween to show it in a diagram format in operation S208. Further, a static analysis process may be automated by showing detailed descriptions for the class and method.

In this regard, the static analyzer 104 makes the dynamic analyzer 108 to indicate detailed contents of each class and method in order that the dynamic analyzer 108 utilize the information analyzed as such to make comparison and analysis so that the static analyzer 104 finally provides the users with construction and function, data and control stream of the mobile application in an easy format to understand. In addition, the static analyzer 104 analyzes the permission contents defined in the relevant mobile application, that is, whether a network access is permitted, whether a Wi-Fi (Wireless-Fidelity) access is permitted, whether an Internet access is permitted, and whether an external storage is permitted, so that they may be utilized when the dynamic analyzer 108 makes the comparison and analysis.

The data analyzed by the static analyzer 104 are stored in the database 102, and the automatic execution processor 106 automatically draws possible test cases on the basis of the control and data stream analysis result that are derived from the static analysis in operation 5210.

Next, the static analyzer 108 generates automatic execution scripts to automatically execute the execution file using the test cases drawn as described above in operation. The static analyzer 108 then generates various formats of logs by executing the automatic execution scripts automatically so that database of the dynamic analysis in the next step is prepared.

In this regard, the process of generating the automatic execution scripts and the process of generating the logs may reduce omitted test cases occurring when the dynamic analysis is manually performed and log data generation time for the dynamic analysis that needs much time using the scripting and execution, so that it is possible to reduce security inspection time with respect to the mobile application.

As such, the dynamic analyzer 108 compares and analyzes results of the control stream, data stream and permission analysis on the basis of the logs and the static analysis results generated by the automatic execution processor 106 and the static analyzer 104 in operation 5214 and finds out whether any patterns indicating the malicious codes were executed.

Thereafter, the dynamic analyzer 108 performs log analysis in each category, for example, network usage, peripheral device such as camera and speaker, and Internet access with respect to the log analysis resulted from the comparison and analysis described above in operation S216, and then performs log analysis in each level using system or application level again in step S218.

Subsequently, the dynamic analyzer 108 analyzes relationship views as to whether the execution files allow unnecessary permission excessively, API (class, method and so on) obtained when the static analysis is performed is executed in a specific order, or whether there is a combination between permission and execution API on the basis of the log analysis result in each category and the log analysis result in each level, and outputs the malicious code analysis result in various formats in operation S220.

As described above, in accordance with the method for automatically inspecting security of applications of the present invention, it is possible to inspect more correctly whether there are malicious codes in the mobile application by extracting source codes of an execution file using a software reverse engineering and analyzing them in order to identify whether malicious codes used to reveal information or the like are concealed in the execution file of a mobile application before the application is downloaded and installed in a mobile communication terminal such as smart phone, making a test result with respect to many test cases using an automatic emulation and generating information mixed of static and dynamic analyses.

That is, in accordance with the present invention, when inspecting an execution file of the application, the execution file is changed to a higher-level language of Java level using a reversing other than dump level of a memory and analyzed. Further, in order to automate a dynamic analysis, a test case is automatically generated on the basis of data stream of a static analysis. Further, in order to generate an amount of dynamic analysis data, an automatic script is generated and executed, and the static analysis result and the result obtained by executing the automatic scripting are integrated so that automation is made to analyze the malicious codes in a short time. Furthermore, data having a high legibility are collected and analyzed using reversing so that users can inspect security with ease.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for automatically inspecting security of mobile applications, the apparatus comprising:
a static analyzer configured to perform a static analysis by reversing an execution file of the mobile application;
an automatic execution processor configured to generate an automatic execution script used to automatically execute the execution file and execute the automatic execution script automatically to generate a log; and
a dynamic analyzer configured to analyze whether a pattern of malicious codes was executed in the execution file using the result of the static analysis and the log resulted from the automatic execution.

2. The apparatus of claim 1, wherein the static analyzer performs a structural analysis, a permission analysis, and control and data stream analysis of the execution file by the reversing.

3. The apparatus of claim 1, wherein the static analyzer automates a process of the static analysis by making a detailed description for a class and a method of the execution file.

4. The apparatus of claim 1, wherein the automatic execution processor generates a test case automatically using information generated by the static analysis, and generates the automatic execution script on the basis of the test case.

5. The apparatus of claim 1, wherein the dynamic analyzer analyzes control stream, data stream and permission for the execution file using the result of the static analysis and the log resulted from the automatic execution, thereby drawing a log analysis result, and analyzes the drawn log analysis result in each category and each level, thereby analyzing whether the pattern of malicious codes was executed in the execution file.

6. The apparatus of claim 5, wherein the log analysis in each category is performed for networks, peripheral devices or Internet accesses in which the execution file is used.

7. The apparatus of claim 5, wherein the log analysis in each level is performed for the system or application levels in which the execution file is executed.

8. A method for automatically inspecting security of mobile applications, the method comprising:
performing a static analysis by reversing an execution file of the mobile application to be analyzed;
generating a script to automatically execute the execution file;
executing the script automatically to generate a log; and
analyzing whether a pattern of malicious codes was executed in the execution file using the result of the static analysis and the log resulted from the automatic execution.

9. The method of claim 8, wherein said performing the static analysis comprises:
analyzing a structure of the execution file by the reversing;
analyzing whether a permission defined in the execution file is appropriate; and
analyzing control and data stream of the execution file.

10. The method of claim 8, wherein said generating the log comprises:
generating a test case automatically using information generated by the static analysis;
generating a script to automatically execute the execution file on the basis of the test case; and
generating a log by automatically executing the script.

11. The method of claim 8, wherein said analyzing whether a pattern of malicious codes was executed in the execution file comprises:
performing analyses of control streams, data streams and permissions for the execution file using the result of the static analysis and the log resulted from the automatic execution, thereby drawing a log analysis result; and
analyzing whether the pattern of malicious codes was executed in the execution file by analyzing the drawn log analysis result in each category and each level.

12. The method of claim 11, wherein the log analysis in each category is performed for networks, peripheral devices or Internet accesses in which the execution file is used.

13. The method of claim 11, wherein the log analysis in each level is performed for systems or application files in which the execution file is executed.
